(19) United States
(12) Patent Application Publication
(10) Pub. No.: US 2010/0184418 A1
(43) Pub. Date: Jul. 22, 2010

(54) Methods and Devices for Control of Explicit Call Transfer

(75) Inventors: Rogier Noldus, Goirle (NL); Alfonso Pisani, Scafati (IT); Biagio Maione, Napoli (IT)

Correspondence Address: COATS & BENNETT, PLLC, 1400 Crescent Green, Suite 300, Cary, NC, 27518, US

(73) Assignee: TELEFONAKTIEBOLAGET LM ERICSSON (PUBL), Stockholm (SE)

(21) Appl. No.: 12/664,358

(22) PCT Filed: Jun. 15, 2007
(86) PCT No.: PCT/NL2007/050288

§ 371 Date: Jan. 11, 2010

(51) Int. Cl. H04W 4/16

(52) U.S. Cl. 455/417

(57) ABSTRACT

The invention relates to a method for controlling an explicit call transfer during a call in a telecommunications network comprising a switching node and an intelligent network, the intelligent network comprising a service control entity and a service switching entity. The service switching entity detects that explicit call transfer is invoked, and then sends a report to the service control entity indicating that explicit call transfer took place for the call. The report may comprise the call transfer number and a call transfer phase indicator indicating whether the call is active or in alerting state. The service control entity receives the report and will control the call transfer depending on the report.

### TECHNICAL FIELD

The present invention relates to a method for controlling explicit call transfer in a telecommunications network.

### BACKGROUND

Explicit Call Transfer (ECT) supplementary service enables a mobile subscriber (subscriber A) who has two calls, each of which can be an incoming or an outgoing call, to connect the two other subscribers (subscribers B and C) to each other and release his connection with the Mobile Switching Center (MSC). The ECT supplementary service for the GSM network and for the third generation mobile network (3G network) is specified by 3GPP in the following technical specifications (TS): 22.091 version 6.0.0, 23.091 version 6.0.0 and 24.091 version 6.0.0.

The Customized Applications for Mobile network Enhanced Logic (CAMEL) feature is a GSM Phase 2+ and UMTS network feature providing the mechanisms to support operator-specific services that are not covered by standardized GSM or UMTS services, even while a mobile subscriber is roaming outside the Home PLMN (HPLMN). When a call is subjected to the control by a Service Control Point (SCP) via e.g. the CAMEL Application Part (CAP) protocol, subscriber A is basically the “served subscriber” that has an IN category (O-CSI, D-CSI, T-CSI, VT-CSI . . . ) due to which the SCP is linked in the traffic chain for controlling the call and/or being notified of events happening during the call. When the SCP is invoked due to an O-CSI, D-CSI, N-CSI or VT-CSI with CAP v3 or CAP v4, the SCP may use a CAP Continue With Argument (CWA) or CAP Connect (CON) operation to instruct the MSC to allow the served subscriber to invoke ECT during the call or to instruct the MSC to disallow the served subscriber to invoke ECT during the call.

A problem may occur when the SCP instructs the MSC to allow the served subscriber to invoke ECT during the call. In such case, the served subscriber may invoke ECT during the call, possibly resulting in unexpected service behaviour, such as incorrect or unexpected announcements played to the parties of the call, incorrect charging to be applied for the calls or incoming calls not being delivered to the served subscriber.

### SUMMARY OF THE INVENTION

A goal of the present invention is to provide methods, devices and computer programs that overcome aforementioned problem and improve the control of explicit call transfer in a telecommunications network.

This goal is achieved by providing a method for controlling an explicit call transfer during a call in a telecommunications network comprising a switching node and an intelligent network, the intelligent network comprising a service control entity and a service switching entity. The service switching entity detects that explicit call transfer is invoked. It will then send a report to the service control entity indicating that explicit call transfer took place for the call. The service switching entity will then receive an instruction from the service control entity indicating how to continue the call, and it will execute that instruction. The service switching entity makes the service control entity aware of an ECT invocation by the served subscriber so that the service control entity can take appropriate actions.

In a further aspect, the invention relates to a method for controlling an explicit call transfer during a call in a telecommunications network comprising a switching node and an intelligent network, the intelligent network comprising a service control entity and a service switching entity. The service control entity receives a report from the service switching entity indicating that explicit call transfer took place for the call. It will then process the report and send an instruction to the service switching entity depending on the result of the processing of the report.

The invention further relates to a method for controlling an explicit call transfer during a call in a telecommunications network comprising a switching node and an intelligent network, the intelligent network comprising a service control entity and a service switching entity, wherein the service switching entity detects that explicit call transfer is invoked. It will then send a report to the service control entity indicating that explicit call transfer took place for the call. The service control entity receives the report from the service switching entity indicating that explicit call transfer took place for the call and the service control entity will then process the report. Next, the service control entity sends an instruction back to the service switching entity depending on the result of the processing of the report. The service switching entity receives the instruction from the service control entity indicating how to continue the call and then the service switching entity executes the instruction.

The invention also relates to a service switching entity for an intelligent network which provides intelligent network services to users of a telecommunications network. The intelligent network comprises a service control entity connectable to the service switching entity. The service switching entity is connectable to a switching node in the telecommunications network, and comprises a processing unit, an input unit connected to the processing unit and an output unit connected to the processing unit, wherein the input unit is arranged to receive messages from the switching node and to receive instructions from the service control entity. The processing unit is arranged to:
detect that explicit call transfer is invoked;
send a report to the service control entity via the output unit indicating that explicit call transfer took place for this call;
receive an instruction from the service control entity via the input unit indicating how to continue the call;
execute the instruction.

The invention further relates to a service control entity for an intelligent network which provides intelligent network services to users of a telecommunications network where the service control entity is connectable to a service switching entity in the intelligent network, and comprises a processing unit, an input unit connected to the processing unit and an output unit connected to the processing unit. The input unit is arranged to receive messages from the service switching entity, and the processing unit is arranged to:
receive a report via the input unit from the service switching entity indicating that explicit call transfer took place for the call;
process the report;
send an instruction via the output unit to the service switching entity depending on the result of the processing of the report.

Finally, the invention relates to a computer program product comprising computer executable code, which when loaded on a computer system, allows the computer system to execute the method as described above.

### BRIEF DESCRIPTION OF THE DRAWINGS

The present invention will be discussed in more detail below, using a number of exemplary embodiments, with reference to the attached drawings, in which:

FIG. 1 schematically shows part of a telecommunication network according to an embodiment of the invention;

FIG. 2 shows a simplified form of a structure of an MSC, SSF or SCP;

FIG. 3 schematically shown an O-BCSM (Originating BCSM);

FIG. 4 reflects the functioning of a state of the art ECT invocation when two calls (i.e. subscriber A-subscriber B and subscriber A-subscriber C) are answered;

FIG. 5 shows part of the telecommunications network via which subscriber A (i.e. the served subscriber) is connected to subscriber B and C;

FIG. 6 shows the telecommunications network of FIG. 5 after the served subscriber A successfully invokes ECT;

FIG. 7 schematically shows an O-BCSM (Originating BCSM) as specified by 3GPP, with enhancement according to an embodiment;

FIG. 8 shows a traffic example according to an embodiment, in which the calling subscriber A having O-CSI is engaged in two active calls and invokes ECT service;

FIG. 9 shows a traffic example according to an embodiment, in which the calling subscriber A having O-CSI is engaged in an active call with subscriber C;

FIG. 10 is an example for the case in which the SCP is notified of ECT invocation and decides to release the call because the service logic of the SCP requires that the served subscriber must be in the call;

FIG. 11 shows an example for the case in which the SCP requires charging information with existing operations Apply Charging (ACH)/Apply Charging Report (ACR) and then releases the call after receiving the ECT notification from the SSF;

FIG. 12 shows a flow chart of the actions taken by an SSF according to an embodiment;

FIG. 13 shows a flow chart of the actions taken by an SCP according to an embodiment.

### DETAILED DESCRIPTION OF THE INVENTION

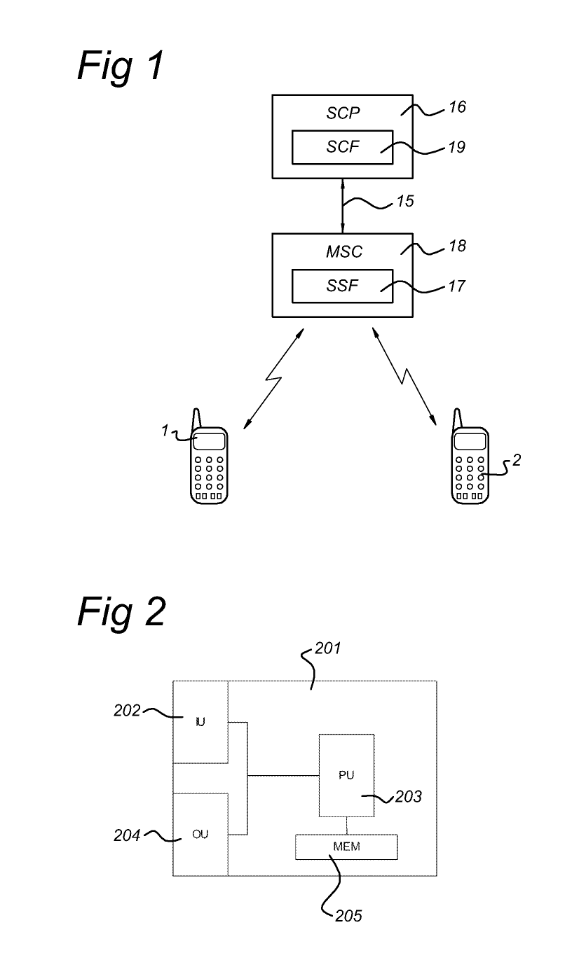

The present invention may be applied in communication networks, e.g. a mobile telecommunication network. The relevant parts of such a telecommunication network for the present invention are shown schematically in FIG. 1. The telecommunication network provides for communication between two or more terminals 1, 2, 3, of which one is designated originating terminal 1, and another one destination terminal 2. The terminals 1, 2 (or mobile stations) are arranged to communicate wirelessly with a switching node, in this case the Mobile Switching Center (MSC) 18. The MSC 18 is arranged to establish a call between an originating terminal 1 and a destination terminal 2. In modern mobile telecommunication networks, the MSC 18 also hosts a (software) module for interfacing with other network units in the telecommunication network, indicated by the block Service Switching Function (SSF) 17. An SSF is a service switching entity that complies with the ETSI or 3GPP CAMEL specifications is referred to as GSM Service Switching Function (gsmSSF). The remainder of the present document uses the term ‘SSF’ to denote both a generic SSF and a gsmSSF. The SSF 17 may also be implemented as a separate node, called a Service Switching Point (SSP). Present day telecommunication networks offer intelligent network (IN) services, which are executed by a service control entity, such as the Service Control Point (SCP) 16 shown in FIG. 1. The SCP 16 hosts functional modules, such as the Service Control Function (SCF) 19, and is able to communicate with the SSF 17, e.g. using a messaging protocol such as CAMEL (Customized Applications for Mobile Enhanced Logic) or INAP (Intelligent Networks Application Part).

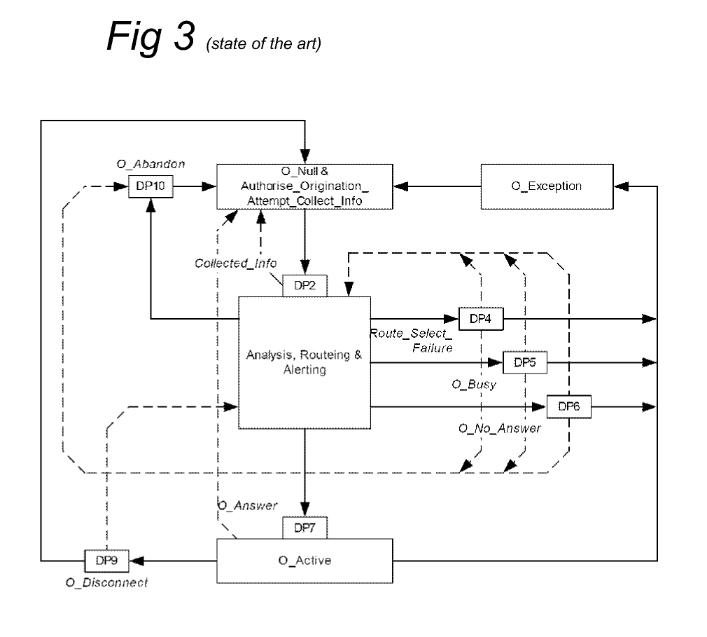

The MSC 18, SSF 17 and the SCP 16 may be implemented as network units 201, the structure of which is shown in simplified form in FIG. 2. The network unit 201 comprises a processing unit 203 connected to an input unit 202. Furthermore, the processing unit 203 is connected to an output unit 204. These allow the processing unit 203 to communicate with other network units 203 or with other elements in the communication network. The processing unit 203 may comprise a general purpose central processing unit (CPU) or a group of interconnected CPU's, or alternatively a dedicated processing unit, e.g. a signal processing unit. A memory module 205 may also be provided and may be used to store data, but may also be used to store a software program comprising instructions, which allows for using the processing unit 203 for various processing functions. E.g. it is possible that one network unit 201 under the control of a software program fulfils the function of the MSC 18 and at the same time the function of the SSF 17.

The method described below in accordance with a number of embodiments of the present invention entails that the SSF 17 uses a state model method well known in present day telecommunication networks called Basic Call State Model (BCSM).

A BCSM can be described using the following elements:

Points in Call

Detection points

Transitions

Events

Calls progress through a series of states that correspond to Points in Call (PiCs). Each state change represents a transition that is precipitated by one or more events. Those PiCs where a transfer of control can occur between the SSF 17 and the SCP 16 have an associated detection point (DP). A DP may also relate to an event that, when it occurs, does not result in a state transition. This situation is sometimes referred to as ‘transition to the same state’. DP processing allows the transition to be seen by the SCF 19 through an event reporting mechanism. First, the SCF 19 performs a so-called Request Report BCSM operation. This operation is used to request the SSF 17 to monitor for a call-related event (e.g., BCSM events such as busy or no-answer), then send a notification back to the SCF 17 when the event is detected. Next, the SSF 17 performs a so-called Event Report BCSM operation which is used to notify the SCF 19 of a call related event, provided that the reporting of the occurrence of this event was previously requested by the SCF 19 in the Request Report BCSM operation. The monitoring of more than one event can be requested with a single Request Report BCSM operation. Each requested event is reported in a separate Event Report BCSM operation.

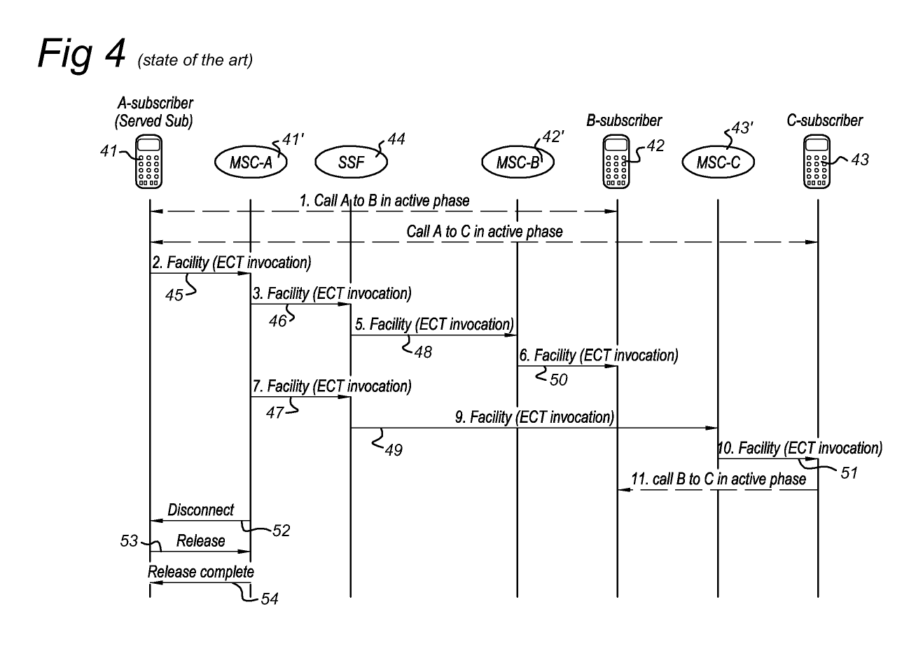

An instance of a BCSM is invoked when the MSC 18 has deduced that a call shall be subject to IN control. The type of BCSM that is instantiated depends on the call case. For a Mobile Originating (MO) call for which a CAMEL service shall be invoked, an O-BCSM (Originating BCSM) is instantiated, as is schematically shown in FIG. 3. The O-BCSM consists of various DPs and PiCs, such as the indicated O_Active PiC. The basic call transitions are indicated by solid lines, and transitions beyond basic call are indicated by broken lines. Basic state model transitions are those transitions that follow from the structure of the BCSM. State model transitions beyond basic call are those transitions that are enforced by a service control entity.

Two types of DPs can be defined:
trigger DPs (TDPs), statically armed;
event DPs (EDPs), dynamically armed under control of the SCF 17.

When a DP is ‘armed’, the SSF may send a notification to the SCP when an event related to that DP occurs.

Detection points, when armed and met, cause event reports to be sent to the SCP 16. An event report can be a notification or a request. A notification informs the SCP 16 of an event and a request specifically requests assistance from the SCP 16. A request implies, in addition to the aforementioned notification, a transfer of control to the SCP 16.

FIG. 4 reflects the functioning of a state of the art ECT invocation when two calls (i.e. subscriber A-subscriber B and subscriber A-subscriber C) are answered. In FIG. 4, the mobile terminal 41, 42, 43 of subscribers A, B and C respectively are shown together with their corresponding MSC instances MSC-A 41′, MSC-B 42′ and MSC-C 43′. An SSF 44 is shown that is in communication with MSC-A.

Prior to invoking explicit call transfer, see arrow 45, the connection of the call between subscriber A and subscriber B must have been established and subscriber A must have put subscriber B on hold. On the call between subscriber A and subscriber C, either the connection must have been established prior to transfer, or, transfer can occur while subscriber C is being alerted of the call. When the execution of ECT supplementary service is complete, both subscribers B and C are notified that ECT has been invoked, with an ISDN User Part (ISUP) or Bearer Independent Call Control (BICC) Call Progress (CPG) message in the case that the call to the subscriber is in alerting phase, or with an ISUP/BICC Facility (FAC) message in the case that the call to the subscriber is in active state, see arrows 46, 47, 48, 49, 50, 51. When an MSC and its associated SSF are located in the same node, said ISUP or BICC messages may have the form of a vendor-specific internal ISUP/BICC equivalent message. Once the MSC-A 41′ has sent the FAC or CPG messages, it sends a DISCONNECT message to the mobile terminal 41, see arrow 52, which in return sends a RELEASE message back, see arrow 53. Finally, the MSC-A 41′ sends a RELEASE COMPLETE message to the mobile terminal 41, see arrow 54. Note that for simplicity reasons, the MSC-A 41′ and SSF are shown once only (the call leg A-B and the call leg A-C have their own MSC process instance, SSF process instance and SCF instance). The term ‘leg’ or ‘call leg’ is common terminology in circuit switched telecommunication; it is used, amongst others, within the description of MSC or SSF; it refers to the logical connection to or from a party in a call.

The CPG or FAC messages mentioned above may contain also the number of the other subscriber the call is connected to from that moment on (that is B-number for subscriber C and C-number for subscriber B). This number is carried in a parameter called “Call Transfer number”; it is referred in the remainder of the description. This parameter is defined in ITU-T recommendation Q.732.7 (1996), “Stage 3 description for call offering supplementary services using Signalling System No. 7: Explicit Call Transfer”.

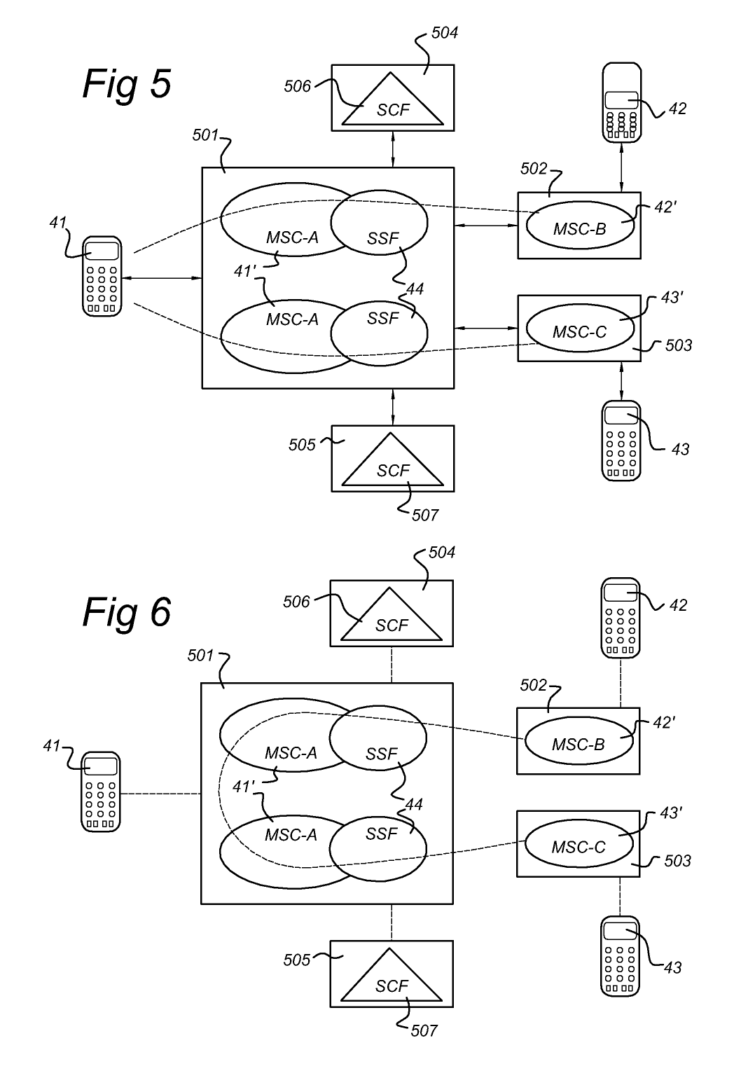

FIG. 5 shows part of the telecommunications network via which the terminal 41 used by subscriber A (i.e. the served subscriber) is connected to the terminal 42 and to the terminal 43 used by subscriber B and C respectively. The telecommunications network comprises at least three MSCs 501, 502 and 503. The MSC 501 is arranged to set up a call from the terminal 41 via a MSC 502 to terminal 42, and via MSC 503 to terminal 43. In this example, the telecommunications network also comprises two SCPs 504 and 505. FIG. 5 depicts the situation before the served subscriber A invokes ECT. Two originating calls have been started from subscriber A. Two logical instances of MSC-A 41′ and SSF 44 are created on the MSC 501. ISUP or BICC signalling is used between the respective MSCs, depending on monolithic or layered architecture. The DTAP protocol is used between the terminals 41, 42, 43 and their corresponding MSCs 501, 502, 503 respectively. Each of the two logical instances SSF 44 is in communication with a gsmSCF instance 506, 507 loaded on the SCP 504 and on the SCP 505. In FIG. 5, two dashed lines indicate the communication between the terminals 41 and 42, and between terminal 41 and 43.

FIG. 6 shows the scenario after the served subscriber A successfully invokes ECT. After ECT invocation, neither the SCP 504 for the call A-B nor the SCP 505 for the call A-C is aware that served subscriber A is not part of the call any longer. Therefore, whatever tone, announcement or notification of events on the call leg between the SSF 44 and the served subscriber A is requested by the SCP 504, would actually be referred to subscriber C using terminal 43. This means, for example, that an announcement or a tone played due to an order from the SCP 504 and giving information that is of interest for served subscriber (subscriber A), would be heard by subscriber C. Another example is constituted by the case where the SCP 504 is interested in served subscriber's (subscriber A) disconnection. Actually, if the SCP 504 had armed disconnection event on the leg between SSF and served subscriber (i.e. leg 1 for the A-B call) it would be subscriber C disconnection to be reported, but actually served subscriber A has already been disconnected the moment when ECT had been invoked successfully.

The invention aims at making SCP 504 aware of an ECT invocation by the served subscriber so that the SCP 504 can take appropriate actions.

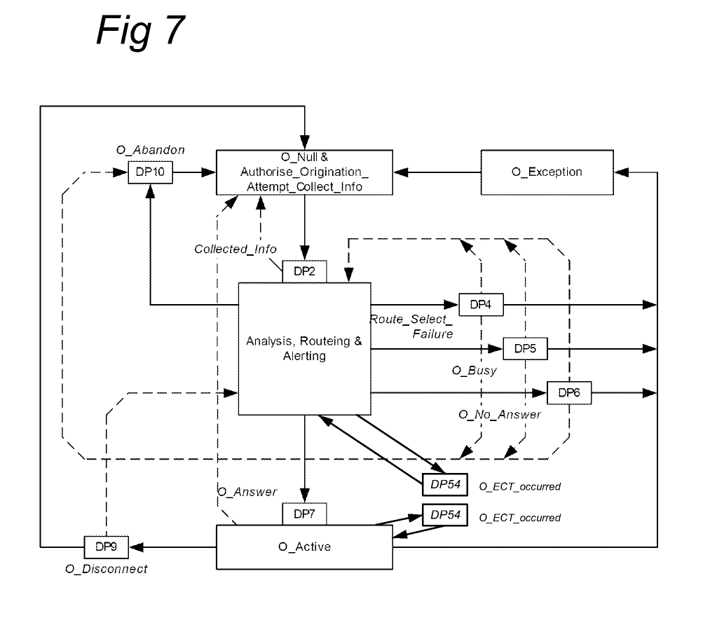

FIG. 7 shows an O-BCSM (Originating BCSM) as specified by 3GPP, with enhancement according to an embodiment of the present invention. The BCSM includes a new detection point (with numerical reference DP54), ‘O_ECT_Occurred’. This DP occurs when the call for which this BCSM is instantiated is subject to ECT. The DP may occur from two places in the O-BCSM: (1) from the Point in Call (PIC) ‘Analysis, routing & alerting’ and (2) from the PIC ‘O_Active’. In the former case, the occurrence of DP O_ECT_Occurred from the PIC ‘Analysis, routing & alerting’, relates to the case that ECT is invoked when the call is in alerting phase. In the latter case, the occurrence of DP O_ECT_Occurred from the PIC ‘O_Active’, relates to the case that ECT is invoked when the call is active. When the SSF 44 receives the FAC message or the CPG message, it checks whether this message contains an indication that ECT has occurred. When the SSF 44 ascertains that this message relates indeed to the occurrence of ECT, the DP O_ECT_Occurred occurs. When this DP occurs, the SSF 44 will send a notification to the SCP 504, provided that the SCP 504 had previously armed this DP in this BCSM instance. The notification will include the call transfer number, as well as an indication of the phase in which the event took place.

Similar to the enhancement to the O-BCSM, as shown in FIG. 7, a Detection Point named ‘T_ECT_Occurred’ (DP55), is added to the Terminating BCSM (T-BCSM). Please note that FIG. 7 shows the O-BCSM, including DP54. The T-BCSM, including the DP55, is not shown.

Basically, the SCP 504 will take into account the ECT successful invocation and the new connected subscriber. By receiving the event report (ERB), the SCP 504 obtains information from the network about successful ECT invocation by the served subscriber, and the new connected subscriber. This information can be used to apply service logic taking into account the new connected subscriber and act appropriately, considering that a subscriber that was in the call is no longer connected in the call. The embodiment described above can be implemented as follows:

a) adding a new EDP to the Basic Call State Models (BCSM) for CAMEL: “call transfer invoked” to indicate that ECT has been invoked on the call leg encountering the DP;

b) adding a BCSM event in the Request Report BCSM operation and in the Event Report BCSM operation to arm and report (respectively) the new EDP at point a);

c) adding a new information field in the ERB operation; this new information field will contain said call transfer number, as well as an indication of the phase of the call in which the call transfer took place.

The following enhancements to the CAP protocol may be introduced to provide the SCP 504 with the capabilities described above:

a) add a new Event Type O_ECT_Occurred and T_ECT_Occurred in the Event Report BCSM operation to specify that ECT was invoked. The event for which the Event Report BCSM operation is sent from SSF to SCP is indicated in the parameter ‘Event Type BCSM’.

The Event Report BCSM operation may contain the parameter ‘Event Specific Information BCSM’. If the Event Type BCSM IE contains either “O_ECT_Occurred” or “T_ECT_Occurred”, then the Event Specific Information BCSM parameter contains the following information elements:

| Information element name | Description |
|---|---|
| Call Transfer Phase | This IE is used to indicate whether ECT was |
| | invoked during alerting phase or active phase |
| | for the call leg encountering the event. |
| Call Transfer Number | This IE is used to indicate the number the |
| | call leg has been transferred to. |

b) add a new event type “O_ECT_Occurred” and “T_ECT_Occurred” in the Request Report BCSM operation to arm the new EDPs mentioned above.

The following table shows a possible mapping between ISUP FAC/CPG parameters and corresponding CAP ERB parameters in DP specific info. ISUP parameters are taken from ITU-T Recommendation Q.763 (1999). Please note that in the case of ECT invocation, the Notification Indicator Parameter contained in Generic Notification Indicator (this parameter is present both in ISUP FAC and CPG) can be received by the SSF 44 with values “call transfer, alerting” or “call transfer, active”.

| Parameters in FAC/CPG | Parameters in ERB |
|---|---|
| Call transfer number | Call Transfer Number |
| Generic notification indicator | Call Transfer Phase |
| (Notification Indicator subparameter) | |

A possible ASN.1 coding for the Call Transfer Phase is the following:

CallTransferPhase
ENUMERATED {

callTransferAlerting (105),
callTransferActive (106)
}

Coding for Call Transfer Number can be exactly the same as for ITU-T Recommendation Q.763 (1999) and is depicted below.

| | 8 | 7 | 6 | 5 | 4 | 3 | 2 | 1 |
|---|---|---|---|---|---|---|---|---|
| 1 | O/E | Nature of address indicator | | | | | | |
| 2 | spare | Numbering plan | | | Address presentation | | Screening | |
| | | indicator | | | restricted indicator | | indicator | |
| 3 | 2nd address signal | | | | 1 st address signal | | | |
| . | | | | | | | | |
| . | | | | | | | | |
| . | | | | | | | | |

| | | |
|---|---|---|
| M | Filler (if necessary) | nth address signal |

c) Modify the Basic call state model to include the two new DPs that will be hit when the basic call in the SSF 44 receives a FAC/CPG message indicating that ECT was invoked. If the DP was previously armed in the BCSM instance for this call, the SSF 44 will send an ERB to the SCF 506 indicating “O_ECT_Occurred” or “T_ECT_Occurred” depending upon whether the SSF 44 was invoked in an originating or in a terminating call respectively. The SSF 44 will populate DP specific info with the Call Transfer number received in the ISUP FAC/CPG message as well as with the indication of the phase of the call in which the ECT took place.

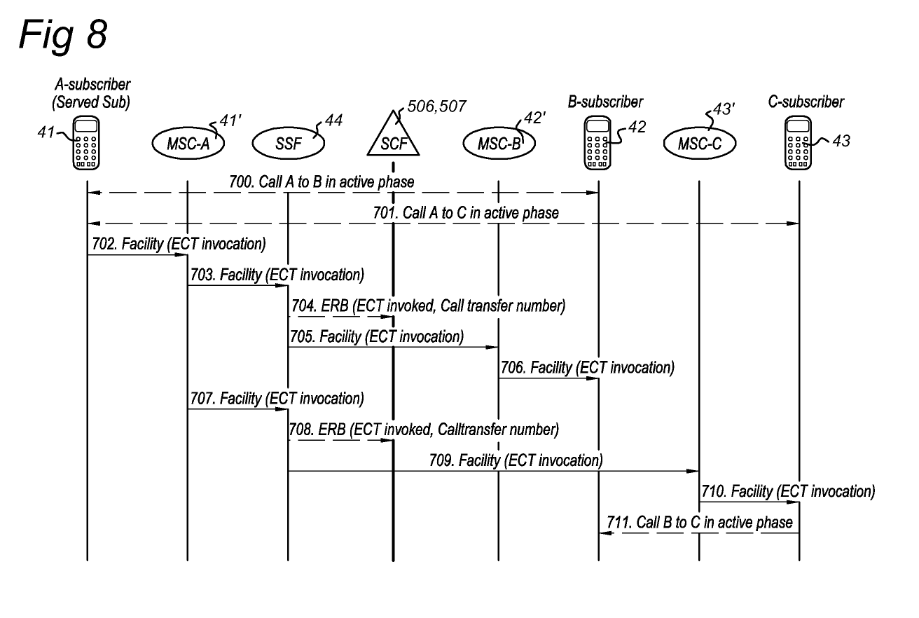

FIG. 8 shows a traffic example according to an embodiment, in which the calling subscriber A having O-CSI (served subscriber) is engaged in two active calls and invokes ECT service. In this embodiment, the gsmSCF 506 is notified about ECT invocation and will then take decisions based on the service logic to be applied. For simplicity the MSC-A 41′ and the SSF 44 are shown once only (the call leg A-B and the call leg A-C have their own MSC process instance, SSF process instance and gsmSCF instance). In FIG. 8, call A to B and call A to C are in the active state, see arrows 700, 701. At a certain moment, the subscriber A (served subscriber) invokes the ECT service, see arrow 702. A FAC message is sent from one of the MSC-A 41′ instances to the associated SSF instance 44 of the A-B call with ECT invocation indication, see arrow 703. The SSF instance 44 intercepts the FAC message and reports the ECT event to the gsmSCF 506 with the call transfer number (i.e. number of subscriber C), see arrow 704. The gsmSCF 506 obtains information related to the call transfer number and applies service logic based on the obtained information. The FAC message is sent to the MSC-B instance 42′, see arrow 705, which forwards it to subscriber B, see arrow 706. A second FAC message is sent from the MSC-A instance 41′ to SSF instance 44 of A-C call with ECT invocation indication, see arrow 707. The SSF instance 44 intercepts the FAC message and reports the event to the associated gsmSCF 507 with the call transfer number (i.e. number of subscriber B), see arrow 708. The gsmSCF 507 obtains information related to the call transfer number and applies service logic based on the obtained information. A FAC message is sent to the MSC-C 43′, see arrow 709, which forwards it to the terminal 43 of subscriber C, see arrow 710. Next, speech connection between B and C is established, see arrow 711.

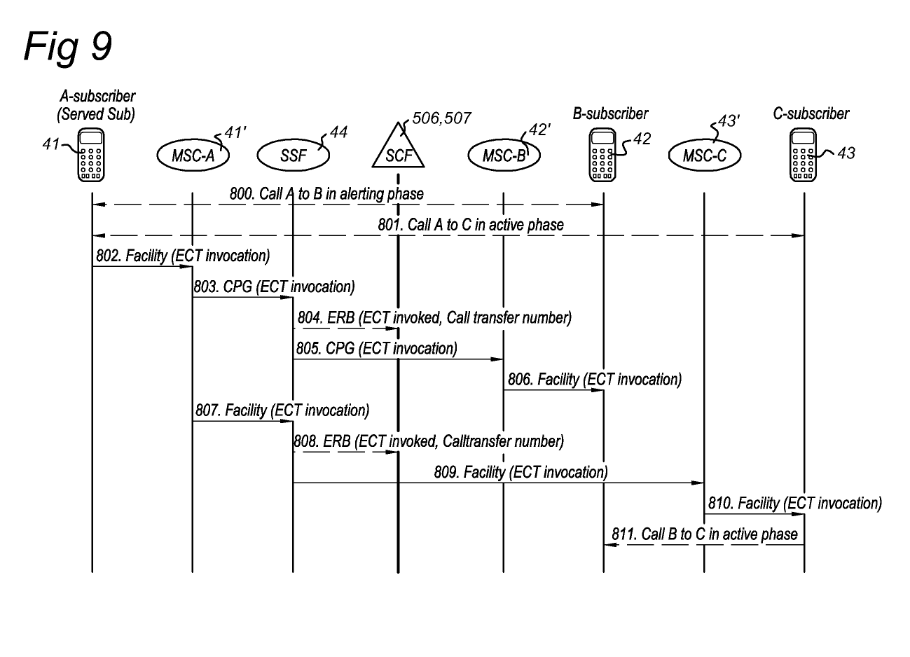

FIG. 9 shows a traffic example according to an embodiment, in which the calling subscriber A having O-CSI (served subscriber) is engaged in an active call with subscriber C, see arrow 801, and in alerting phase with subscriber B, arrow 800. At a certain moment, the subscriber A (served subscriber) invokes the ECT service, see arrow 802. A CPG message is sent from one of the MSC-A instances 41′ to the associated SSF instance 44 of the A-B call with ECT invocation indication, see arrow 803. The SSF instance 44 intercepts the CPG message and reports the ECT event to the gsmSCF 506 with the call transfer number (i.e. number of subscriber C), see arrow 804. The gsmSCF 506 obtains information related to the call transfer number and applies service logic based on the new information. The CPG message is sent to MSC-B 42′, see arrow 805, which forwards it to subscriber B, see arrow 806. A FAC message is sent from the MSC-A instance 41′ to SSF instance of A-C call with ECT invocation indication, see arrow 807. The SSF 44 intercepts the FAC message and reports the ECT event to the associated gsmSCF 507 with the call transfer number (i.e. number of subscriber B), see arrow 808. The gsmSCF 507 obtains information related to the call transfer number and applies service logic based on the obtained information. The FAC message is also sent to the MSC-C 43′, see arrow 809, which forwards it to the terminal 43 of subscriber C, see arrow 810. Next, speech connection between B and C is established, see arrow 811.

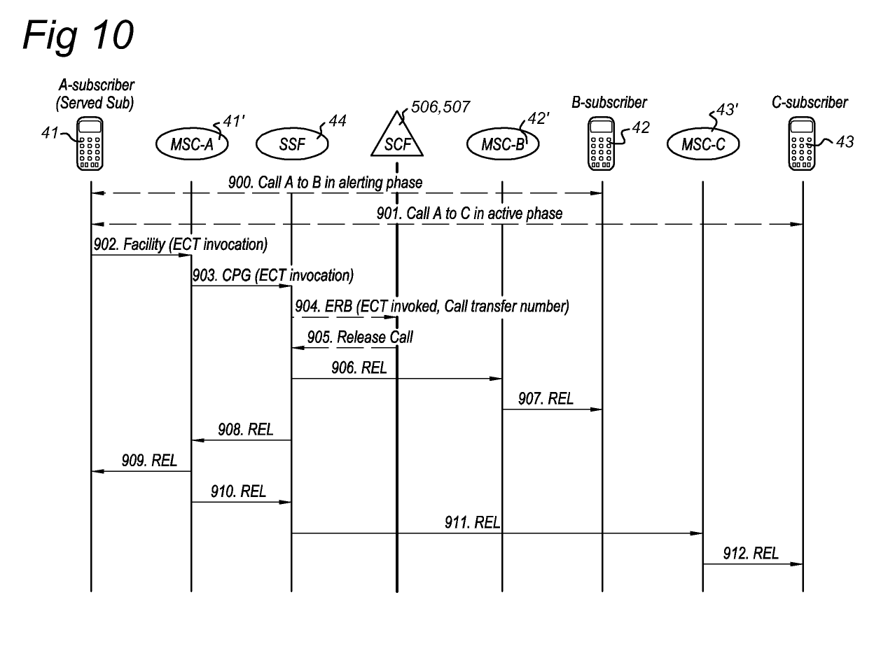

In FIG. 10 an example is depicted for the case in which the SCP 506 is notified of ECT invocation and decides to release the call because the service logic of the SCP 506 requires that the served subscriber (i.e. subscriber A) must be in the call. In this example, the service has decided, at the time of call establishment, that ECT is allowed. However, when the subscriber A has established a second call and wants to invoke ECT, the service decides that this particular combination of calls does not qualify for ECT. For simplicity MSC-A, SSF and SCF are shown once only in FIG. 10. In this example, a first call A to B is in the alerting phase, see arrow 900, and second call A to C is in the active state, see arrow 901. The subscriber A invokes the ECT service, see arrow 902. A CPG message is sent from the MSC-A instance to the SSF instance of A-B call with ECT invocation indication, see arrow 903. The SSF intercepts the FAC message and reports the event to SCF with the call transfer number (i.e. number of subscriber C), see arrow 904. The SCF obtains information related to the call transfer number and instructs SSF to release the call, see arrow 905. The call to subscriber B is released, see arrows 906, 907. The call from subscriber A is also released, see arrows 908, 909. Finally, the call to subscriber C is released, see arrows 910, 911, 912.

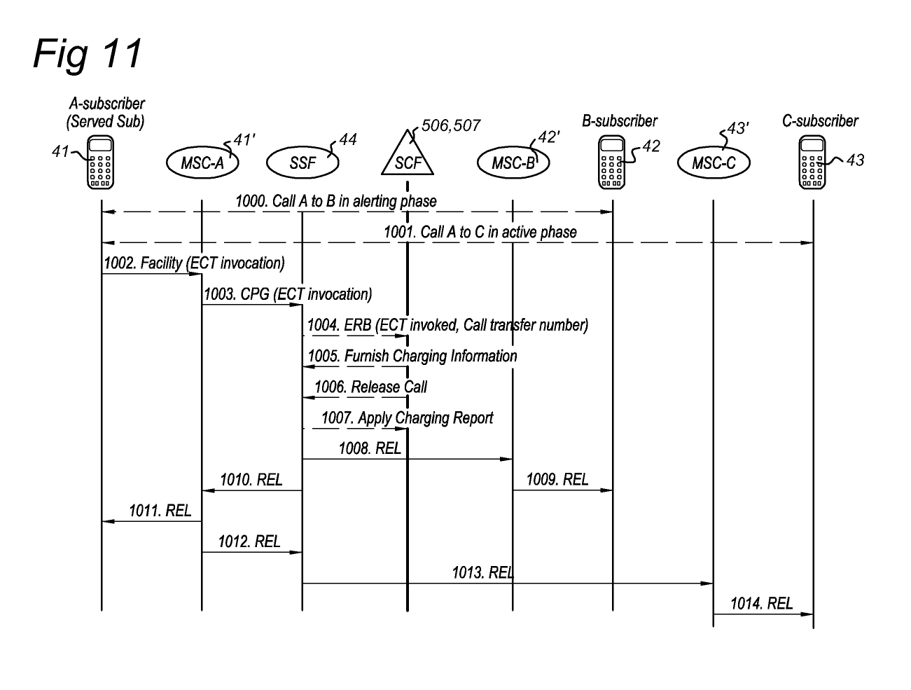

In FIG. 11, an example is shown for the case in which the SCP 506 requires charging information with existing operations ACH/ACR and then releases the call after receiving the ECT notification form the SSF 44. Arrow 1000 indicates that a first call from subscriber A to B is in alerting phase, and arrow 1001 indicates a call from subscriber A to C in an active state. At a certain moment, the subscriber A (served subscriber) invokes the ECT service, see arrow 1002. A CPG message is sent from the MSC-A instance 41′ to the SSF instance 44 of the A-B call with ECT invocation indication, see arrow 1003. The SSF instance 44 intercepts the CPG message and reports the event to the SCF 506 with the call transfer number, see arrow 1004. The SCF 506 obtains information related to the call transfer number (i.e. number of subscriber C), and instruct the SSF 44 to put in the Call Detail Record (CDR) the Call-Transfer-Number, see arrow 1005 and then instructs the SSF to release the call, see arrow 1006. The SSF 44 returns charging information at the end of the disconnection by means of a so-called Apply Charging Report operation, see arrow 1007. The call to subscriber B is then released, see arrows 1008, 1009. Next, the call from subscriber A is released, see arrow 1011. Then, the call to subscriber C is released, see arrows 1012, 1013, 1014.

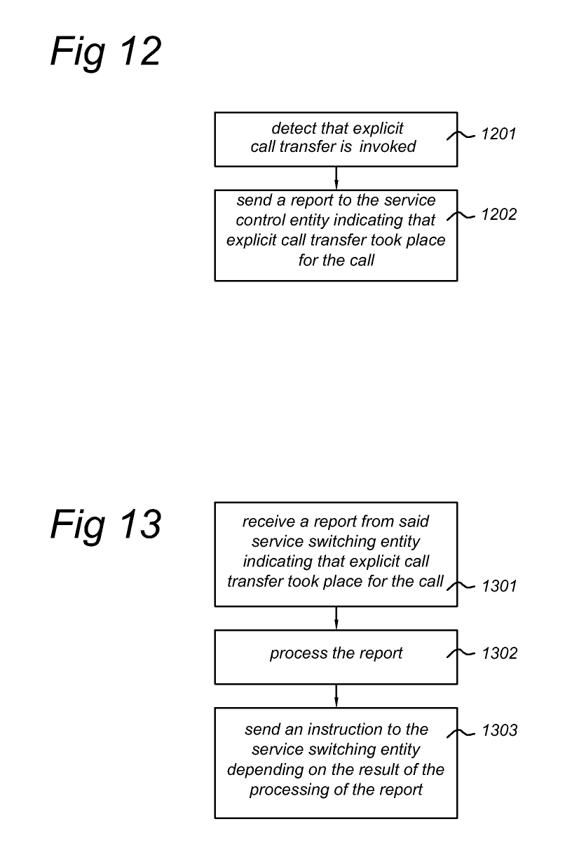

FIG. 12 shows a flow chart of actions that are performed by the service switching entity during a call in the telecommunications network. First, the service switching entity detects that explicit call transfer is invoked, see step 1201. Next, the service switching entity sends a report to the service control entity indicating that explicit call transfer took place for that call, see step 1202.

According to an embodiment, the service switching entity is the SSF 44 of an IN as described above. The SSF 44 will create an instance of a BCSM. The BCSM comprises an event detection point indicating that explicit call transfer was invoked. See also FIG. 7. The SSF 44 will then receive a request from the SCP 16 for reporting to the SCP 16 that an event related to the event detection point has occurred. Next, the SSF 44 receives a message from the switching node 18. The SSF 44 will ascertain that the message from the switching node 18 constitutes the event related to the event detection point and, send an event report to the SCP 16 if the message constitutes said event. The event report comprises a call transfer number and an indication of the phase of the call, e.g. during an active call or during an alerting phase of the call, in which the event took place.

FIG. 13 shows a flow chart of actions taken by the service control entity. The service control entity receives a report from the service switching entity indicating that explicit call transfer took place for the call, see step 1301. Then, the service control entity processes the report, see step 1302. Next, the service control entity sends an instruction to the service switching entity depending on the result of the processing of the report, see step 1303.

In an embodiment, the service control entity is the SCP 16 of the IN as described above. The SCP 16 creates an instance of a BCSM. Then it sends a request to said SSF 17 for a report from the SSF 17 when an event related to the event detection point has occurred. Next, the SCP 16 receives an event report from the SSF 17 when the event related to the event detection point has occurred. The event report comprises a call transfer number and an indication of the phase of the call, e.g. during an active call or during an alerting phase of the call, in which the event took place.

The invention gives the SCP 506 the ability not only to forbid invocation of ECT service in a particular call, but also to allow invocation of ECT and to know which subscribers are in the call and who has left, when ECT was invoked. Based on this information, the SCF can apply appropriate service logic taking into account the new connected subscriber.

In an embodiment, the SCP 506 is arranged not to send an “end of call balance notification” Unstructured Supplementary Service Data (USSD) message to the subscriber that invoked the explicit call transfer service, if she is no longer in the call. Without the invention, the served subscriber would receive the USSD message, whilst she might by then already be engaged in another call or may otherwise not expect the USSD message.

According to a further embodiment, the SCP is arranged to correctly handle ECT invoked by hunt group agents. When a hunt group agent or call distribution group agent transfers an incoming or outgoing call to another destination, the service logic will be notified that the agent is now available again for receiving calls. Without the invention, the agent would remain marked as “busy”, which has the effect that she can't receive incoming calls whilst she is in fact available.

When the SCP 506 is informed that the served subscriber has invoked ECT, the SCF will know that the served subscriber no longer occupies a radio channel over the radio access network. In an embodiment, the SCP 506 is arranged to adapt (reduce) the rate of the call when the served subscriber is no longer in the call.

In a further embodiment, the SCP 506 is arranged to decide not to play announcements or tones towards the served subscriber after ECT invocation. Without the invention, these announcements or tones would be heard by the subscriber C or the subscriber B instead of by the served subscriber.

In an embodiment, the SCP 506 is arranged to forbid ECT depending on the result of the processing of the report of the SSF 44. The SCP 506 may decide to forbid ECT depending on one or more criteria. More specifically, criteria that can only be checked during the call, such as, for example, the call transfer number. When the subscriber establishes a call, the SCP 506 instructs the SSF 44 to allow ECT to be invoked by the served subscriber. When the served subscriber wants to invoke ECT, the service may, however, decide that this particular combination of calls does not qualify for ECT and to release the call. For example, an enterprise may decide that ECT is allowed only between connected parties that also belong to this enterprise.

In yet another embodiment, the SCP 506 is arranged to allow the call for which ECT was invoked to continue. The SCP 506 may adapt its service logic processing, considering the new call connection that has become effective due to the explicit call transfer.

On top of these new possibilities the operators will be allowed to build up new Value Added Services and to have a better interaction between these services and ECT.

The present invention has been explained above with reference to a number of exemplary embodiments. As will be apparent to the person skilled in the art, various modifications and amendments can be made without departing from the scope of the present invention, as defined in the appended claims. The invention could also be implemented in wireline networks, e.g. ISDN.

### List of Abbreviations

3rd Generation Partnership Project
ACH Apply Charging (CAP Operation)
ACR Apply Charging Report (CAP Operation)
ANM Answer (ISUP message)
ASN.1 Abstract Syntax Notation nr. 1
BCSM Basic Call State Model
BICC Bearer Independent Call Control (call control protocol used in ISDN)
CAMEL Customised Applications for Mobile network Enhanced Logic
CAP CAMEL Application Part
CD Call Deflection (GSM supplementary service)
CDMA Code Division Multiple Access
CPG Call Progress (ISUP message)
CON Connect (CAP Operation)
CS1 Capability Set 1
CS1+ Ericsson enhancement to CS1
CWA Continue With Argument (CAP Operation)
D-CSI Dialed Service CAMEL Subscription Information
DP Detection Point
DTAP Direct Transfer Application Part
ECT Explicit Call Transfer (GSM supplementary service)
EDP Event Detection Point
ERB Event Report BCSM (CAP operation)
FAC Facility (ISUP message)
FCI Furnish Charging Information
GMSC Gateway Mobile services Switching Centre
GSM Global System for Mobile communication
gsmSCF CAMEL Service Control Function
gsmSSF CAMEL Service Switching Function
HPLMN Home PLMN
IAM Initial Address Message (ISUP message)
ICA Initiate Call Attempt (CAP operation)
IDP Initial Detection Point (CAP Operation)
IE Information Element
IF Information Flow
IMSI International Mobile Station Identifier
IN Intelligent Networks
INAP IN Application Part
ISDN Integrated Services Digital Network
ISUP ISDN User Part
ITU International Telecommunication Union
MAP Mobile Application Part
MPTY Multi Party (GSM supplementary service)
MS Mobile Station
MSC Mobile services Switching Centre
MSISDN Mobile Station International ISDN Number
N-CSI Network CAMEL Subscription Information
O-BCSM Originating BCSM
O-CSI Originating CAMEL Subscription Information
PLMN Public Land Mobile Network
REL Release (ISUP message)
RRB Request Report BCSM (CAP operation)
SCP Service Control Point
SSF Service Switching Function
SS-CSI Supplementary Service CAMEL Subscription Information
SSIN Supplementary Service Invocation Notification
T-BCSM Terminating BCSM
T-CSI Terminating CAMEL Subscription Information
UE User Equipment
USSD Unstructured Supplementary Service Data
VLR Visited Location Register
VMSC Visited Mobile Switching Centre
VT-CSI VMSC Terminating CAMEL Subscription Information
W-CDMA Wideband CDMA

1-14. (canceled)

15. A method for controlling an explicit call transfer during a call in a telecommunications network comprising a switching node and an intelligent network, the intelligent network comprising a service control entity and a service switching entity, said service control entity being external from said switching node, and wherein said method comprises, at the service switching entity:
detecting that explicit call transfer is invoked;
sending a report to the service control entity indicating that explicit call transfer took place for the call;
receiving an instruction from the service control entity indicating how to continue the call; and
executing the instruction.

16. The method of claim 15, wherein said service switching entity detects that explicit call transfer is invoked by way of:
creating an instance of a Basic Call State Model (BCSM), said BCSM comprising an event detection point related to the invocation of explicit call transfer;
receiving a message from the switching node; and
ascertaining that said message constitutes an event related to said event detection point.

17. The method of claim 15, wherein said report comprises a call transfer number.

18. The method of claim 15, wherein said report comprises a call transfer phase parameter indicating whether the explicit call transfer is invoked during an active call or during an alerting phase of a call.

19. A method for controlling an explicit call transfer during a call in a telecommunications network comprising a switching node and an intelligent amended claims network, the intelligent network comprising a service control entity and a service switching entity, said service control entity being external from said switching node, said method comprising, at the service control entity:
receiving a report from said service switching entity indicating that explicit call transfer took place for the call;
processing said report; and
sending an instruction to said service switching entity depending on the result of the processing of said report.

20. The method of claim 19, wherein before receiving said report, said service control entity sends a request to said service switching entity for a report from said service switching entity notifying the invocation of an explicit call transfer service.

21. The method of claim 19, wherein said report comprises an indication of a call transfer number.

22. The method of claim 19, wherein said report comprises an indication of the phase of the call in which the event took place.

23. The method of claim 19, wherein the instruction may take one of the following forms:
disallowing the call to continue depending on the result of said processing of the report;
allowing the call to continue and adapting its service logic processing, considering the new call connection that has become effective due to the explicit call transfer;
avoiding sending an end-of-call-balance notification to a served subscriber that invoked the explicit call transfer service; and
adapting a rate of the call.

24. The method of claim 19, wherein said report constitutes a notification on behalf of an agent of a hunt group or a call distribution group, indicating that said agent is available, and wherein the service control entity marks said agent as being available for receiving calls.

25. A method for controlling an explicit call transfer during a call in a telecommunications network comprising a switching node and an intelligent network, the intelligent network comprising a service control entity and a service switching entity, said service control entity being external from said switching node, and said method comprising:
said service switching entity detecting that explicit call transfer is invoked;
said service switching entity sending a report to the service control entity indicating that explicit call transfer took place for the call;
said service control entity receiving said report from said service switching entity;
said service control entity processing said report;
said service control entity sending an instruction to said service switching entity depending on the result of the processing of said report;
said service switching entity receiving said instruction from the service control entity indicating how to continue the call; and
said service switching entity executing the instruction.

26. A service switching entity for an intelligent network which provides intelligent network services to users of a telecommunications network, the intelligent network further comprising a service control entity connectable to the service switching entity, the service switching entity being connectable to a switching node in the telecommunications network, wherein the service control entity is external from said switching node, and wherein the service switching entity comprises:
a processing unit;
an input unit connected to the processing unit; and
an output unit connected to the processing unit;
wherein the input unit is arranged to receive messages from the switching node and to receive instructions from the service control entity, and further wherein the processing unit is configured to:
detect that explicit call transfer is invoked;
send a report to the service control entity via the output unit indicating that explicit call transfer took place for this call;
receive an instruction from the service control entity via the input unit indicating how to continue the call; and
execute the instruction.

27. A service control entity for an intelligent network which provides intelligent network services to users of a telecommunications network comprising a switching node, said service control entity being external from said switching node, the service control entity being connectable to a service switching entity in the intelligent network, and comprising:
a processing unit;
an input unit connected to the processing unit; and
an output unit connected to the processing unit;
wherein the input unit is arranged to receive messages from the service switching entity, and further wherein the processing unit is configured to:
receive a report via the input unit from said service switching entity indicating that explicit call transfer took place for the call;
process said report; and
send an instruction via the output unit to said service switching entity depending on the result of the processing of said report.
